(19) United States
(12) Patent Application Publication
(10) Pub. No.: US 2014/0117681 A1
(43) Pub. Date: May 1, 2014

(54) Security Door Lock Device

(71) Applicant: Heath O. Jenkins, Flowood, MS (US)

(72) Inventor: Heath O. Jenkins, Flowood, MS (US)

(21) Appl. No.: 13/694,125

(22) Filed: Oct. 31, 2012

(51) Int. Cl. E05C 19/18

(52) U.S. Cl. CPC E05C 19/184
USPC 292/256.71

(57) ABSTRACT

A high security adjustable keyless locking contrivance for preventing the forced opening of a hinged door of unoccupied homes or buildings. An engaging apparatus that incorporates an armor structural plate combined with a structural cylinder and a threaded bolt shaft, which cylinder inserts into a conventional door bore hole with the bolt shaft passing through the existing door latch assembly in concert. A second armor structural plate combined with a smaller structural cylinder that slides inside the larger cylinder from the opposite side of the hinged door, allowing the penetration of the threaded bolt shaft through the second armor plate bolt hole which will conjoin the two devices with a security nut, thus sandwiching and securing the hinged door and door jamb between the two armor structural plates.

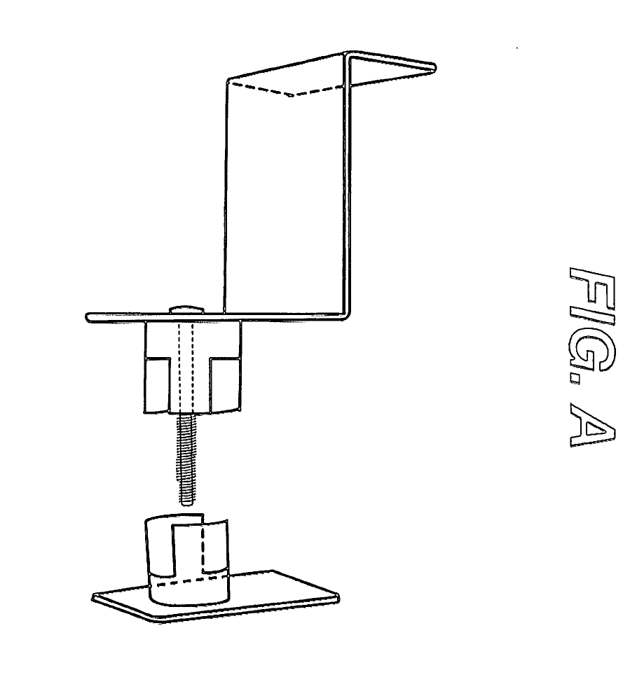

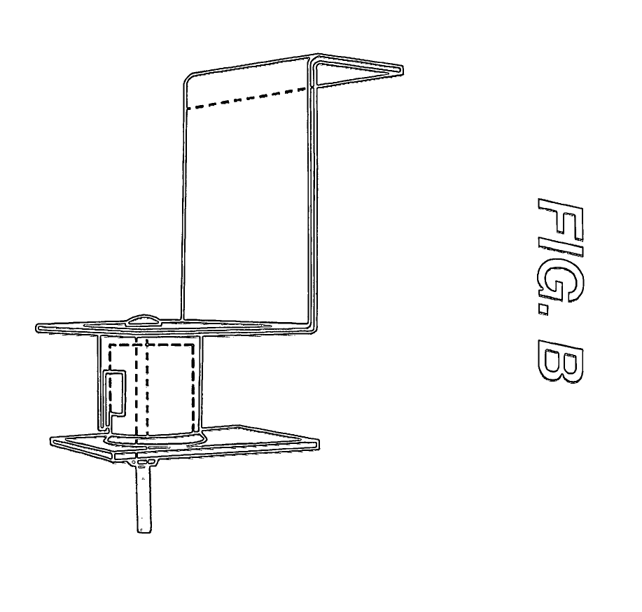

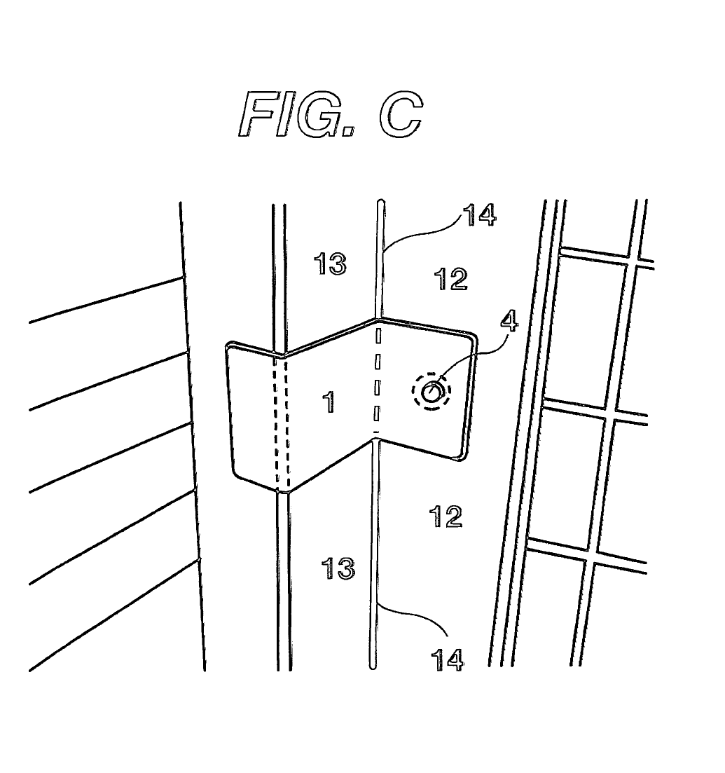

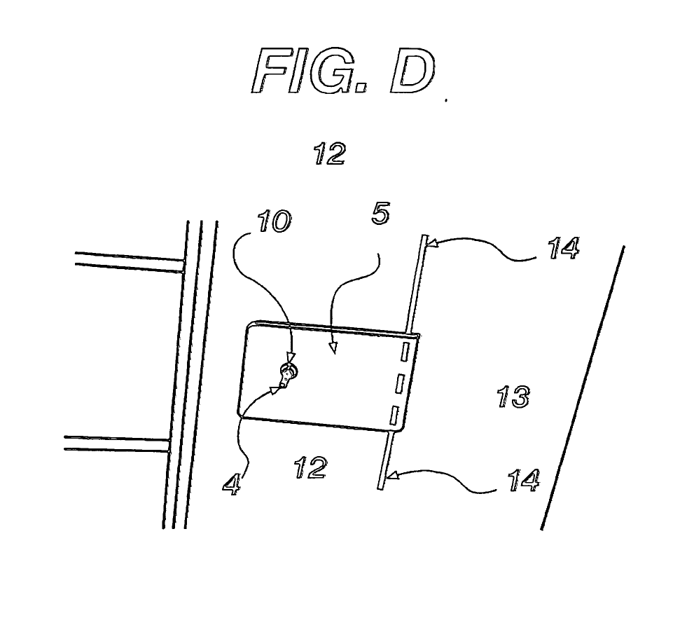

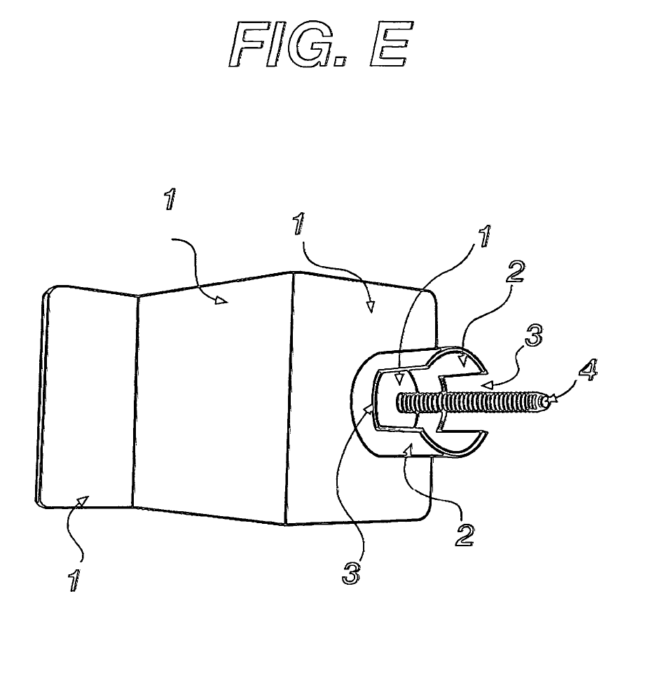

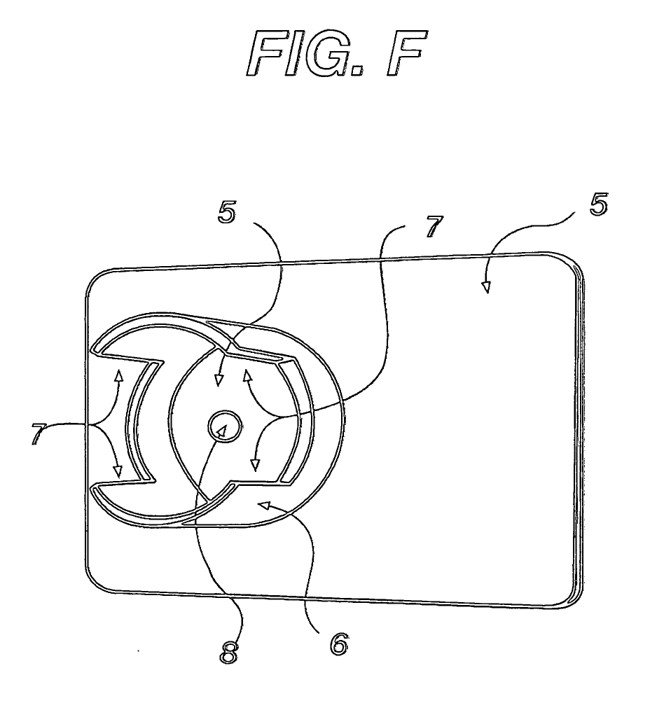

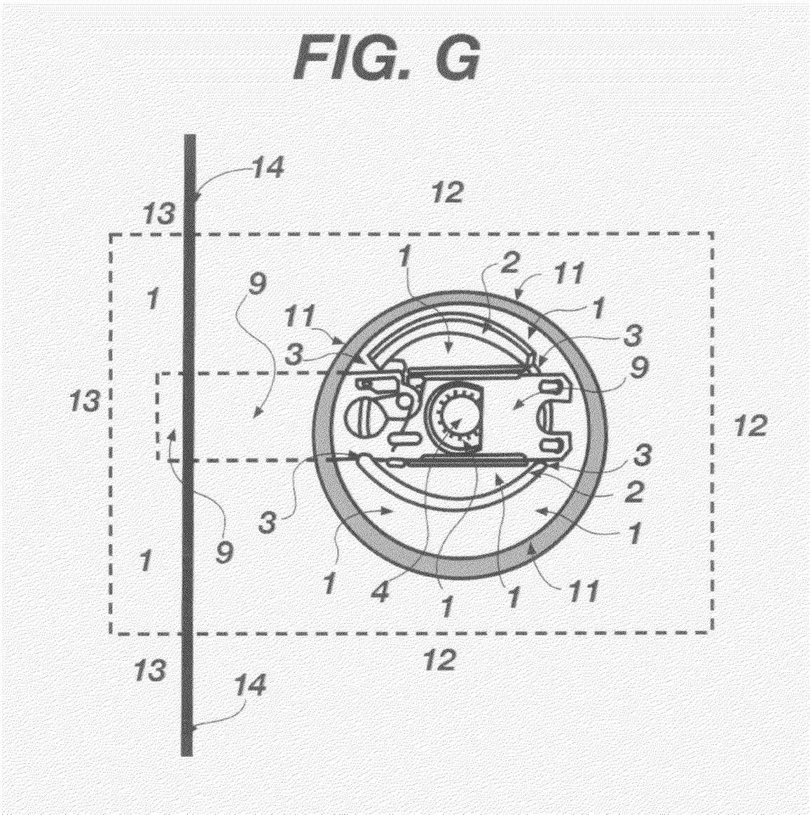

### REFERENCES CITED

U.S. PATENT DOCUMENTS

| | | |
|---|---|---|
| 6,393,878 | March 2002 | Fayngersh, et al. |
| 7,290,415 | November 2007 | Rosenbert, et al. |
| 4,206,132 | May 1977 | Best |
| 4,254,647 | March 1981 | Finck, Jr. |
| 8,061,165 | November 2011 | Cassini |
| 6,688,063 | February 2004 | Lee, et al. |
| 6,502,435 | January 2003 | Watts, et al. |
| 4,472,143 | September 1984 | Bennett, et al. |
| 7,836,736 | November 2010 | Humphris |
| 6,923,028 | August 2005 | Caldwell, et al. |
| 6,481,250 | November 2002 | Calle, et al. |
| 5,873,273 | February 1999 | Vick |
| 5,291,760 | March 1984 | Schrader |
| 4,262,503 | April 1981 | Kuebler |

### RELATED APPLICATION

This patent application claims priority from U. S. Provisional Patent Application Ser. No. 61/629,938, filed Dec. 1, 2011.

### FIELD OF INVENTON

The present invention relates in general to an adjustable keyless security lock engaging apparatus for use in securing hinged doors from forced entry of unoccupied homes and buildings. The present invention is an improvement over known locking devices in that this apparatus prevents hinged doors from being forced or pried open.

### BACKGROUND OF THE INVENTION

Professional contractors have concocted numerous locking systems; however intruders have consistently and successfully overcome all of these systems. For example, the security of a conventional keyed lock and deadbolt is compromised by a forceful prying in the small space between the hinged door and door jamb. Additionally, as reported by the FBI; “84% of the break-ins are due to door jamb failure”. Every lock on the market is only as strong as the door jamb that secures it. With the present invention, the hinged door and door jamb are sandwiched between two armor structural plates that makes it impregnable with conventional hand tools.

More importantly, the present invention prevents these break-ins by the installation of two armored plates, which are secured around the hinged door and the door jamb at the latch mechanism. The exterior part of the armored structural plate completely covers the small space between the hinged door and the door jamb, which is where the latch mechanism is located. This prevents the insertion of a crowbar or other device to force open the hinged door. Another problem with the current keyed lock is that a strong force against the door knob itself will result in failure of the door knob and lock. Door knobs are not designed for forceful trauma. Whereas, the present invention is a flat armor structural plate with no protrusions for any outside forces to be applied.

### SUMMARY OF THE INVENTION

A principle objective of the present invention is to provide an improved high security keyless adjustable apparatus that will secure all hinged doors in unoccupied manufactured and site built homes from forceful entry.

The present invention allows for a simple installation of this security lock device into an existing conventional door bore hole, thus sandwiching the door and jamb between two structural armor plates. This design allows for an easy and efficient installation by simply removing the two screws from the inside face of the door knob and removing the existing door lock assembly but leaving the existing latch mechanism in place. Then from the OUTSIDE of the home, insert the larger structural plate apparatus into the existing door bore hole and around the existing door latch mechanism. Then from the INSIDE of the home, insert the smaller structural plate apparatus into the door bore hole with the threaded bolt penetrating the smaller structural plate and both devices are conjoined with a security nut.

By locking the two apparatuses together with a security nut; the hinged door and the door jamb are sandwiched between the two armor structural plates preventing the exposure of the small space between the hinged door and door jamb where the latch mechanism is located. This provides maximum security from all forced entry.

### BRIEF DESCRIPTION OF THE DRAWINGS

The present invention will be better understood with reference to the appended drawing sheets, wherein:

FIG. A is a SIDE VIEW of the two components comprising the high security keyless lock apparatus of the present invention in the UNSECURED position.

FIG. B is a SIDE VIEW of the two components comprising the high security keyless lock apparatus of the present invention in the SECURED position.

FIG. C is an OUTSIDE VIEW of the larger armor structural plate of the present invention in the SECURED position protecting the door and door jamb of a hinged rear door at the latch mechanism.

FIG. D is an INSIDE VIEW of the smaller armor structural plate of the present invention in the SECURED position sandwiching the hinged door and door jamb and locked with a security nut.

FIG. E is an INSIDE VIEW of the larger armor structural apparatus illustrating the cylinder, slots and threaded bolt.

FIG. F is an INSIDE VIEW of the smaller armor structural plate illustrating the cylinder, slots and bolt hole for the insertion of the threaded bolt.

FIG. G is an INSIDE VIEW of the larger structural cylinder penetrating the existing door bore hole from the OUTSIDE and in concert the threaded bolt penetrates the existing door latch mechanism.

### DETAILED DESCRIPTION

The present invention relates to a High Security Keyless Adjustable Door Lock that prevents the forced opening of all hinged doors of unoccupied homes or buildings. More particularly, the security lock is a two piece apparatus comprising a large configured armor structural plate and a smaller armor structural plate that are conjoined by a threaded bolt and a security nut. PRIOR to the installation on the present invention, the existing door lock has to be removed by simply taking out the two screws from the inside face of the existing door lock and pulling them apart but leaving the door latch mechanism in place. A perspective of the present invention secured in place protecting the hinged door and door jamb at the latch mechanism is:
For an OUTSIDE view refer to FIG C
For an INSIDE view refer to FIG. D.

Referring to FIG. C, OUTSIDE view of the larger armor structural plate 1, FIG. C is configured to snugly fit all exterior hinged door jambs 13, FIG. C, while covering the door/jamb crack 14, FIG. C at the latch mechanism and secured through the rear door bore hole 11, FIG. C with a threaded bolt 4, FIG. C.

An INSIDE view FIG. D shows the smaller armor structural plate 5, FIG. D securing the rear hinged door 12, FIG. D and door jamb 13, FIG. D with a security nut 10, FIG. D thus sandwiching the hinged door and the door jamb between two armor structural plates.

Detailing both components of the High Security Keyless Adjustable Door Lock is as follows: The larger first component of the present invention is a configured armor structural plate 1, FIG. E combined with a structural cylinder 2, FIG. E with two slots 3, FIG. E for inserting into the existing door bore hole 11, FIG. G from the OUTSIDE and said slots 3, FIG. E fit snugly around the existing door latch mechanism 9, FIG. G to keep both apparatuses from rotating. Also, incorporated into the larger armor structural plate 1, FIG. E is a threaded bolt 4, FIG. E that secures the larger armor structural plate 1, FIG. E to the smaller structural plate 5, FIG. F with a security nut 10, FIG. D.

The second component of the present invention FIG. F is a smaller armor structural plate 5, FIG. F combined with a small structural cylinder 6, FIG. F incorporating two slots 7, FIG. F and a predetermined bolt hole 8, FIG. F. This configuration allows for the smaller structural cylinder 6. FIG. F to slide inside the larger structural cylinder 2, FIG. G and around the existing door latch mechanism 9, FIG. G and in concert the threaded bolt 4, FIG. G penetrates the predetermined bolt hole 8, FIG. F to allow for the locking of the two apparatuses together with a security nut 10, FIG. D, thus sandwiching the hinged door 12, FIG. D/12, FIG. C, the outside door jamb 13, FIG. C the inside door jamb 13, FIG. D and the door/jamb crack 14, FIG. C between two armor structural plates.

Having described this invention in detail, those skilled in the art will appreciate that modifications may be made of this invention without departing from its spirit. Therefore, it is not intended that the scope of this invention be limited to specific embodiment illustrated and described. Rather, it is intended that the scope of this invention be determined by the appended claims and their equivalents.

I claim:

1. A keyless security lock engaging apparatus for use with a conventional door bore hole and door latching mechanism, the primary apparatus comprising; an armor escutcheon plate affixed to a larger structural cylinder, with a threaded carriage bolt strategically affixed to the armor escutcheon plate and protruding through the open end of the larger structural cylinder,

2. An obverse apparatus comprising; a smaller structural cylinder affixed to an armor escutcheon plate with a strategically located bolt hole allowing the threaded carriage bolt to penetrate this armor escutcheon plate hole upon installation of the device. A security nut or wing nut for said threaded carriage bolt, allowing for the two parts to be adjustably conjoined,

3. The keyless security lock engaging apparatus of claim 1 wherein the biasing means is a flat larger armor escutcheon plate with a strategically located bolt hole for use on the exterior side of hinged doors on manufactured homes,

4. The keyless security lock engaging apparatus of claim 1, wherein the biasing means is a predetermined multi-shaped larger armor escutcheon plate with a strategically located bolt hole for use the exterior side of hinged doors on site built homes,

5. The keyless security lock engaging apparatus of claim 1 wherein the biasing means is a larger structural cylinder strategically affixed to said larger armor escutcheon plate,

6. The keyless security lock engaging apparatus of claim 1 wherein the biasing means is a predetermined slot or slots along the length of the larger structural cylinder to the armor escutcheon plate for tightly receiving the insertion of the existing door latch mechanism, thus preventing the larger armor escutcheon plate from rotating in the door bore hole,

7. The keyless security lock engaging apparatus of claim 1 wherein the biasing means is a predetermined size and location of a threaded carriage bolt attached to the larger armor escutcheon plate, secured with a locking nut and protruding into and out of the open end of the larger structural cylinder,

8. The keyless security lock engaging apparatus of claim 2 wherein the biasing means is a smaller armor escutcheon plate with a strategically located bolt hole to receive the threaded carriage bolt allowing adjustable conjoining of the two apparatus',

9. The keyless security lock engaging apparatus of claim 2 wherein the biasing means is a smaller structural cylinder strategically affixed to said smaller armor escutcheon plate,

10. The keyless security lock engaging apparatus of claim 2 wherein the biasing means is a strategically placed slot or slots on the open end to tightly receive the insertion of the existing door latch mechanism, thus preventing the smaller armor escutcheon plate from rotating in the door bore hole,

11. The keyless security lock engaging apparatus of claim 1 wherein the biasing means is a full threaded carriage bolt to allow for adjustment for jam abnormalities and to tightly conjoin the two armor escutcheon plates with a security nut or wing nut.
